(19) United States
(12) Patent Application Publication
(10) Pub. No.: US 2004/0003022 A1
(43) Pub. Date: Jan. 1, 2004

(54) Method and system for using modulo arithmetic to distribute processing over multiple processors

(75) Inventors: John Michael Garrison, Austin, TX (US); Roy Allen Janik, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, Armonk, NY

(21) Appl. No.: 10/185,683

(22) Filed: Jun. 27, 2002

(51) Int. Cl. G06F 9/00

(52) U.S. Cl. 709/105

(57) ABSTRACT

A method, system, apparatus, and computer program product are presented for load balancing amongst a set of processors within a distributed data processing system. To accomplish the load balancing, a modulo arithmetic operation is used to divide a set of data elements from a data source substantially equally among the processors. Each of the processors performs the modulo arithmetic operation substantially independently. At a particular processor, a data element is retrieved from a data source, and the processor calculates a representational integer value for the data element. The processor then calculates a remainder value by dividing the representational integer value by the number of processors in the distributed data processing system. If the remainder value is equal to a predetermined value associated with the processor, then the data element is processed further by the processor.

### BACKGROUND OF THE INVENTION

1. Field of the Invention

The present invention relates to an improved data processing system and, in particular, to a method and apparatus for multiple computer or multiple process coordinating.

2. Description of Related Art

Rapidly growing networks, such as wireless telephony networks and the Internet, support the generation, transfer, and collection of rapidly growing volumes of data. In turn, there is a rapidly increasing number of examples of applications, including software components and hardware components, that engage in the analysis of very large volumes of data. This data is often in the form of discrete information elements, such as network packets or files for web sites.

An example of an application that analyzes large volumes of data is a network packet analyzer, which is responsible for examining the packets that flow through a network. A network packet analyzer may inspect each packet for irregularities or for signs of nefarious activity. In many cases, the computational capacity required to perform the necessary analysis on each packet is not available or is not affordable. The result is that the packet analyzer is unable to fully analyze all packets. Packets may be missed or “under-analyzed”, thereby allowing potentially suspicious activity to go undetected.

Another example of an application that analyzes large volumes of data is a web crawler, which is designed to visit web sites and capture web pages and other available information for further processing that is typically computationally burdensome, such as indexing web pages or converting web pages into foreign languages. If the web-crawling application is distributed among multiple systems in order to improve system performance, then mechanisms must be defined to avoid redundant processing of the captured web sites, particularly given the dynamic nature of the World Wide Web in which web sites are constantly added and modified. These mechanisms may entail substantial communication between the instances of the web-crawling application.

An additional example of an application that analyzes large volumes of data is a sensor, which is responsible for monitoring a web server's access log while looking for individual suspicious resource requests as well as irregular patterns, e.g., evidence of software agents that hit the web server with high volumes of activity. The computational capacity to perform the necessary analysis on each web request may not be readily available, making it difficult for the sensor to keep pace with the real-time web traffic that is being processed by the web server. As with the network packet analyzer, suspicious or irregular activity may be missed or the sensor may not be able to provide real-time alerting of suspicious activity.

In each of the cases that are described above, solving the problem merely by distributing the application may not be an effective solution since the need to coordinate the division of labor between the instances of the application requires significant processing and network bandwidth resources. Therefore, it would be advantageous to provide a method and system for coordinating the activities of distributed processors, each of which are processing a portion of a large volume of information, while also minimizing any interprocessor communication.

### SUMMARY OF THE INVENTION

A method, system, apparatus, and computer program product are presented for load balancing amongst a set of processors within a distributed data processing system. To accomplish the load balancing, a modulo arithmetic operation is used to divide a set of data elements from a data source substantially equally among the processors. Each of the processors performs the modulo arithmetic operation substantially independently. At a particular processor, a data element is retrieved from a data source, and the processor calculates a representational integer value for the data element. The processor then calculates a remainder value by dividing the representational integer value by the number of processors in the distributed data processing system. If the remainder value is equal to a predetermined value associated with the processor, then the data element is processed further by the processor.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIGS. 2A-2B depict distributed processing systems in which processors access a common datastream or a common datastore to obtain data elements to be processed;

FIG. 3 depicts an overview of a series of steps that may be performed by each processor in a distributed processing system having multiple processors by which each processor independently determines whether it is responsible for processing a particular data element from a set of multiple data elements;

FIG. 4 depicts the technique of using modulo arithmetic for computing selection values for data elements at each processor in a distributed processing system;

FIG. 5 depicts the extraction of data values from predetermined fields within a data element to compute a representational integer value for the data element prior to computing a remainder value, i.e. a computed selection value; and

FIG. 6 depicts an example in which an embodiment of the present invention is applied to the analysis of a packet stream.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

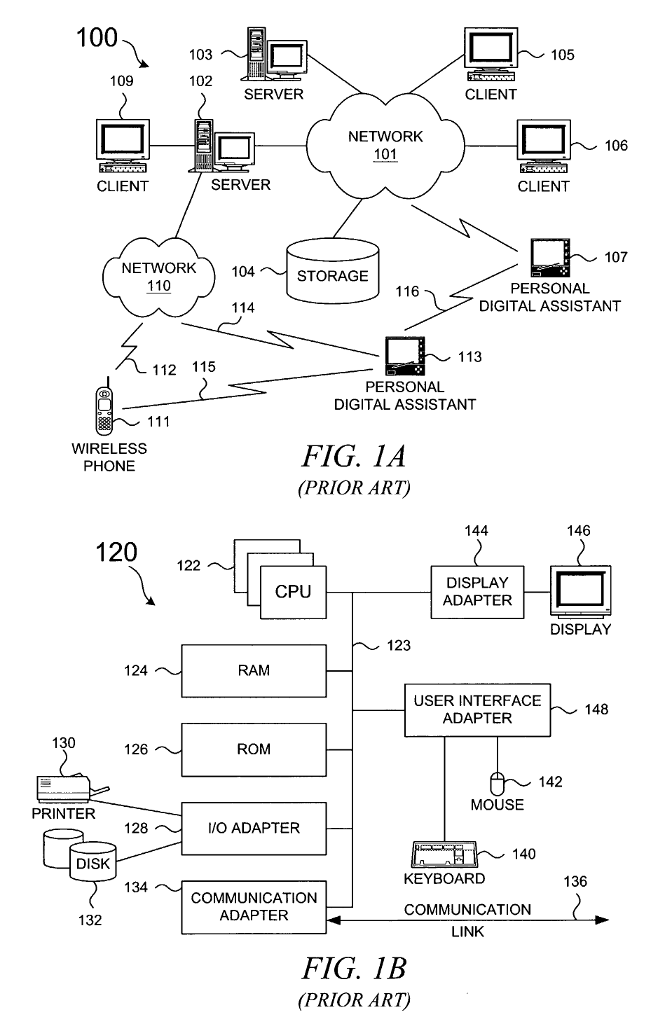

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have multiple processors, such as Intel® Pentium®-based processors and digital signal processors (DSP), and one or more types of volatile and non-volatile memory. Other peripheral devices may be used in addition to or in place of the hardware depicted in FIG. 1B. In other words, one of ordinary skill in the art would not expect to find identical components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment.

The present invention may be implemented on a variety of hardware and software platforms, as described above. More specifically, though, the present invention is directed to a technique for distributing a processing workload across multiple hardware or software processing entities, i.e. distributed processors, when large volumes of data need to be analyzed. The technique of the present invention is described in more detail with respect to the remaining figures.

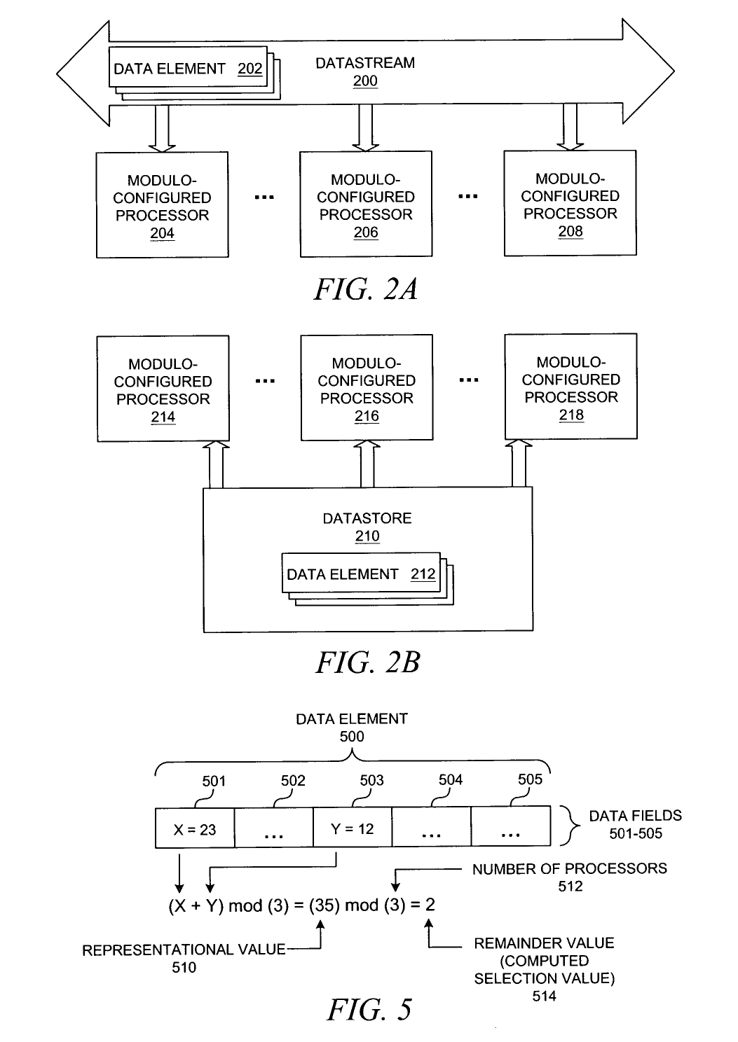

With reference now to FIGS. 2A-2B, block diagrams depict distributed processing systems in which processors access a common datastream or a common datastore to obtain data elements to be processed in accordance with an embodiment of the present invention. FIG. 2A and FIG. 2B depict similar distributed processing systems in which multiple processors within a distributed processing system have shared or common access to a data source.

In the example shown in FIG. 2A, datastream 200 is comprised of data elements 202, which may represent data packets being transported on a network, such as network 101 shown in FIG. 1A. Each processor 204-208 has access to every data element that flows through datastream 200. Processors 204-208 may be hardware processors such as processors 122 shown in FIG. 1B, or processors 204-208 may be software entities, such as applications, applets, or other types of software modules. Processors 204-208 have been previously configured in some manner such that each processor has the ability to perform modulo arithmetic in a manner that is unique across the set of processors 204-208. Each of the processors contains or is associated with modulo arithmetic configuration information. As explained in more detail below, the configuration information provides a unique number to be used in modulo arithmetic operations while examining data elements. The configuration information may be hard-coded or hard-wired so that is unmodifiable after system deployment, e.g., information that is embedded within read-only memory in a hardware processor or information that is embedded in object code of a software processor. Alternatively, the configuration information may be modifiable, e.g., through the use of administrative software that updates the information within a hardware processor or a software processor.

In the example shown in FIG. 2B, datastore 210 may be a centralized database or a distributed database, including the World Wide Web or a similar information system. Datastore 210 is comprised of data elements 212, which may represent data files that need to be processed, e.g., web pages (or the URL for each page) that are retrievable from the World Wide Web or that have been previously retrieved from the World Wide Web. In a manner similar to that described above with respect to processors 204-208 in FIG. 2A, processors 214-218 in FIG. 2B may be software processors or hardware processors that have been previously configured in some manner with information that provides each processor with the ability to perform modulo arithmetic in a manner that is unique across the set of processors 214-218. Each modulo-configured processor has access to every data element 212 in datastore 210.

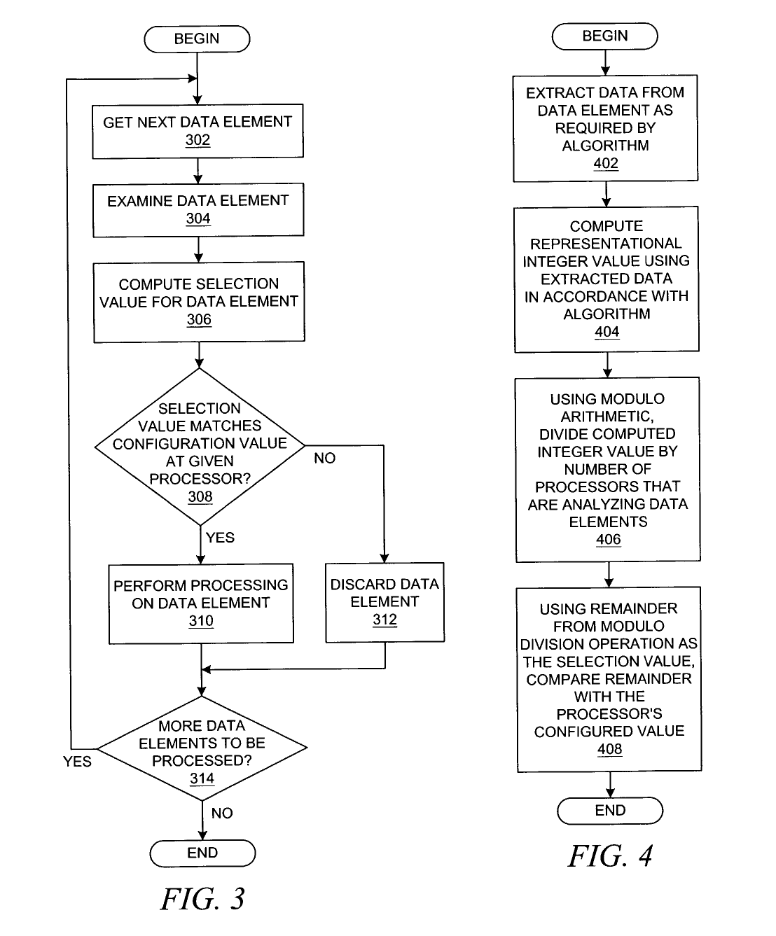

With reference now to FIG. 3, a flowchart depicts an overview of a series of steps that may be performed by each processor in a distributed processing system having multiple processors by which each processor independently determines whether it is responsible for processing a particular data element from a set of multiple data elements. In other words, FIG. 3 illustrates the manner in which a set of processors independently or substantially independently determine which processor should process a particular data element. In this manner, the processors logically divide the data elements in a datastore or in a datastream amongst the set of processors in order to distribute the processing workload amongst the set of processors.

FIG. 3 focuses on the operations of a single processor, herein called the “current” processor, i.e. the processor that is currently being discussed. The flowchart begins when the current processor obtains a next data element in a series or a set of data elements (step 302), e.g., from a datastream or datastore as shown in FIG. 2A or FIG. 2B; the obtained data element can be referred to as the current data element, i.e. the data element which is currently being examined by the processor. If the current data element is the first data element in a newly identified datastream or datastore, then some initial steps (not shown) may have been performed prior to accessing the first data element.

The current data element is then examined in some manner to extract information from the data element (step 304), and the extracted information is then used to compute a selection value for the data element (step 306).

As mentioned above, each process has previously been configured in some manner with information that provides each processor with the ability to perform modulo arithmetic in a manner that is unique across the set of processors in the distributed data processing system. In the exemplary embodiment discussed with respect to FIG. 3, a processor-specific selection value (represented as an integer value) is contained within the configuration information of each processor, and the processor-specific selection value allows each processor in the distributed data processing system to determine independently or substantially independently whether it should perform detailed processing on the current data element. While there may be some interprocessor communication in some implementations for some purposes, the present invention may operate without any or with minimal interprocessor communication; hence, each processor operates independently or substantially independently.

Each processor-specific selection value is unique across the set of processors. Hence, after computing the selection value, a determination is made by the processor as to whether the computed selection value matches a predetermined or previously configured value that is associated with the processor, e.g., the processor-specific selection value (step 308). The technique of using modulo arithmetic to compute the selection value in step 306 is described in more detail below with respect to FIG. 4.

Each processor has been previously configured with a processor-specific selection value. If the computed selection value matches the current processor's processor-specific selection value, then the current processor performs additional detailed processing on the current data element (step 310). Different examples of possible detailed processing on the data elements are shown below in some of the remaining figures. If the computed selection value does not match the current processor's processor-specific selection value, then the processor discards the data element (step 312) and does not perform more detailed processing on the data element.

In either case, the processor then determines whether there are more data elements to be processed (step 314). If so, then the process branches to step 302 to continue examining more data elements, and if not, then the process is complete.

With reference now to FIG. 4, a flowchart depicts the technique of using modulo arithmetic for computing selection values for data elements at each processor in a distributed processing system in accordance with the present invention. FIG. 4 shows further detail for steps 304-308 that are shown in FIG. 3.

The process begins with the extraction of data from a data element that is being analyzed (step 402), such as the “current” data element that was mentioned above with respect to FIG. 3; alternatively, the entire data element may be used rather than just an extracted portion of the data element. The extracted data is then used to compute an integer value in accordance with a predetermined algorithm, wherein the integer value is a representational value for the data element (step 404). For example, the extracted data may be mapped to an integer by hashing the extracted data.

The extracted data that is used as input to the predetermined algorithm may vary with the implementation of the present invention, and the choice/source of data may change over time within a given distributed data processing system. In addition, the predetermined algorithm may also vary with the implementation of the present invention, and the algorithm may change over time. It should be noted, however, that if the algorithm were changed or if the data source were changed, then for a particular data element or for a particular set of data elements, each processor in the distributed processing system would use the same data source and the same algorithm. In this manner, each processor can independently or substantially independently compute the same representational integer value with respect to a particular data element.

The process shown in FIG. 4 then proceeds by using modulo arithmetic, also known as integer division, to divide the computed representational integer value by the number of processors in the distributed data processing system that are analyzing the current data element (step 406), thereby producing a remainder from the modulo division operation. In other words, the number of processors is the divisor for the modulo operation.

Although the number of processors that are employed in the distributed data processing system may change over time for a variety of reasons, e.g., due to a processor failure or due to an administrative decision to add or remove computational resources within the system, each processor in the distributed processing system uses the same divisor with respect to a particular data element. If the number of operational processors changes over time, then the divisor would need to be dynamically updated at each processor through the distribution of updated configuration information in some manner.

It should be noted, however, that if the number of operational processors were changed, then for a particular data element or for a particular set of data elements, each processor in the distributed processing system would use the same number of operational processors in the modulo arithmetic operation. In this manner, each processor can independently or substantially independently compute the same remainder value with respect to a particular data element.

The remainder from the modulo division operation is then used as a computed selection value to determine which processor amongst the processors in the distributed processing system should further process the current data element. As mentioned above with respect to FIG. 2 and FIG. 3, each processor has previously been configured or associated with a processor-specific selection value that is unique across the set of processors in the distributed data processing system. Hence, at each processor, the computed remainder value from the modulo arithmetic operation is compared with the processor's previously configured processor-specific selection value (step 408), and the process shown in FIG. 4 is complete. However, FIG. 4 merely provides an expansion of the processing steps as discussed with respect to FIG. 3, and a positive comparison at step 408 would indicate to a particular processor that further processing of the current data element is required.

Given the description above of the comparison of the computed selection value and the processor-specific selection value, one can note potential errors that may occur if various configurable operands are changed during the operational life of the distributed data processing system without proper interprocessor coordination. As noted above, various configurable operands could be changed during the operational life of the distributed data processing system, such as the number of operational processors, the data source for computing the representational value for a data element, or the algorithm that is used to compute the representational value for a data element. In each case, for a particular data element or for a particular set of data elements, each processor in the distributed processing system should use the same operands because each processor is able to work independently on a particular data element. If different operands were used by different processors when examining a particular data element, different processors would produce different representational values or different remainder values for the same data element, thereby potentially producing erratic results.

Hence, if the operands need to be updated, it would be necessary to have some form of interprocessor communication and/or centralized control for coordinating the update of the operands. In this manner, each processor would complete the examining and processing of a set of data elements before continuing to another set of data elements; after all of the processors have completed the processing of the first set of data elements, the change of operands should not introduce erratic results.

For example, suppose that all of the processors in a distributed data system have a first set of operand values during a first time period, and then at some point in time, all of the processors in the distributed data processing system receive a second set of operand values that are used during a second time period. During the first time period, a first subset of processors would determine that a particular processor in a second subset of processors should further process a given data element; in other words, the first subset of processors would select a particular processor with respect to a given data element. After the operands were changed, i.e. during the second time period, the second subset of processors would determine that a different processor in the first subset of processors should further process the given data element; in other words, the second subset of processors would select a different processor with respect to the given data element. In this scenario, the given data element would remain unprocessed because different processors had been selected, and no processor selected itself. In other words, no processor would determine that it should further process the given data element. Since each processor independently retrieves and examines data elements, a plurality of data elements would potentially remain unprocessed across the two time periods or some date elements would potentially be processed multiple times, and the haphazard selection of data elements could cause unpredictable results that would depend upon the purpose or purposes of the distributed data processing system.

It should also be noted that the distributed data processing system may be implemented with redundancy among the processors. For example, pairs of processors could be deployed wherein each pair of processors share the same processor-specific selection value. Hence, if one processor of a pair goes offline, the other processor of the pair would continue processing. Synchronization between processors, though, would add interprocessor communication.

The process that is described with respect to FIG. 3 and FIG. 4 can be more formally presented in the following manner. Let “N” equal the number of deployed processors within a distributed processing system; “N” is assumed to be a constant number over the span of computations involving a particular data element. Let “V” equal the integer value computed from all or a portion of the particular data element. Let “D” equal the remainder value of the modulo division operation. Each processor is assigned, configured, or associated with a unique processor-specific remainder value within the range of “0” to “N−1”. Each processor has access to every data element that is to be examined, and each processor would perform the following calculation for each data element:

D=V mod N.

Hence, D is calculated, which results in a value in the range of “0” to “N−1”, which can be compared to the unique remainder value associated with the processor that performed the calculation, and this comparison is performed by each processor. For each processor, if the resulting remainder value “D” matches the unique remainder value associated with the processor, it performs additional processing on the data element; otherwise, the processor discards or ignores the data element. Since only one processor has a unique remainder value that will match the calculated remainder value “D”, then only one processor will positively determine to perform additional processing on the data element, i.e. only one processor will perform a “self-selection” operation.

With reference now to FIG. 5, a block diagram depicts the extraction of data values from predetermined fields within a data element to compute a representational integer value for the data element prior to computing a remainder value, i.e. a computed selection value. Data element 500 comprises data fields 501-505. Data field 501 has a reference name of “X”, and data field 503 has a reference name of “Y”. Values for fields 501 and 503 are extracted to compute representational value 510 for data element 500 in accordance with an appropriate algorithm, which in this example is merely an addition operation between the values in data fields 501 and 503. The number of processors in the distributed data processing system is indicated by parameter 512. The remainder of the modulo operation is shown as computer selection value 514. In this example, each processor in the distributed data processing system would examine data element 500, but only the processor that has the configured, processor-specific selection value of “2” would proceed to complete a more prolonged analysis of data element 500.

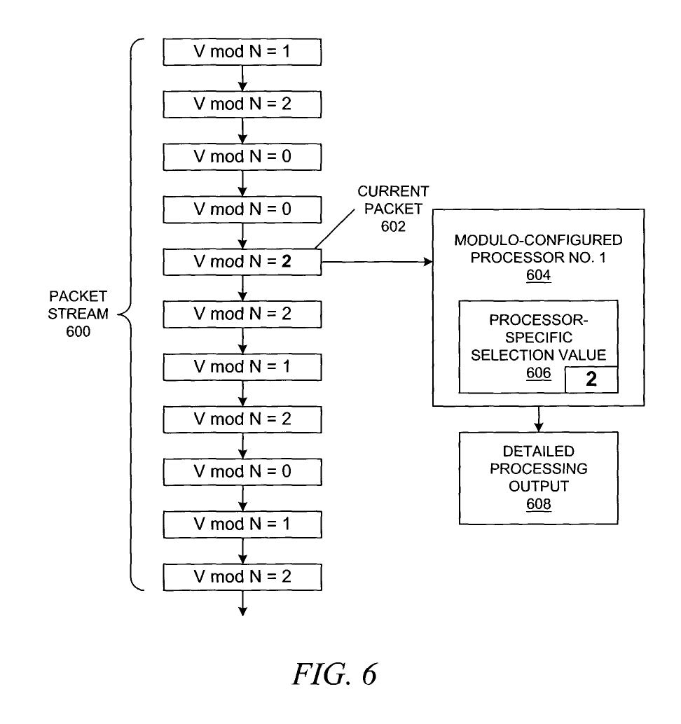

With reference now to FIG. 6, a block diagram depicts an example in which an embodiment of the present invention is applied to the analysis of a packet stream. Packet stream 600 comprises a plurality of data packets. In the example shown in FIG. 6, each data packet is labeled with the results of a computation of a remainder value that would be generated by each processor in the distributed data processing system as described above, wherein “N” equals the number of deployed processors within the distributed processing system and “V” equals the representational integer value computed from all or a portion of the particular data element. The resulting set of representational values should approximate a random sequence if the data fields from which the input values are extracted contain random values, as should be expected if the data fields contain some form of a varying content payload.

Each processor in the distributed data processing system examines each data packet and generates the same resulting remainder value. With respect to “current” packet 602 that is being examined by processor 604 (which has an optional identifier of processor number “1” that is separate from any configuration information), the computed remainder value is equal to the unique, processor-specific selection value 606. Hence, processor 604 selects itself as the processor that is responsible for performing a more thorough analysis of packet 602 and thereafter continues to generate analysis output 608.

As mentioned previously, an example of an application that analyzes large volumes of data is a web crawler, which is designed to visit web sites and capture web pages and other available information for further processing that is typically computationally burdensome, such as indexing web pages or converting web pages into foreign languages. The present invention may be applied in a distributed web-crawling application environment in the following manner.

A web-crawler, also known as a web-spider, typically attempts to visit every web site residing in a top-level domain, such as the “.com” domain, using a fixed algorithm for traversing links. For each web page that is located during the crawling operation, the application might determine if the page is in English, and if so, it might attempt to translate it into other languages prior to indexing and/or storing it. For example, a French version could be stored on a web server, and an index would be created that maps the original English page URL (Uniform Resource Locator) to a URL that points to the French version of the web page. After a web page is located and acquired, significant processing is required to perform the translation. In this example, it is assumed that the traversal of the “.com” domain needs to complete within a specified time period, and it is estimated that the project will require 10,000 instances of the web-crawler application to traverse the domain and convert the English web pages into French.

However, it would be inefficient to have multiple instances of the web-crawler application performing translations of the same web pages. Querying a database to determine if a copy of a translated web page is stored in the database (thereby indicating that a particular web page has already been translated) would introduce significant overhead because each of the 10,000 copies of the web-crawler application would query the database for every page that they encounter. The database would be expected to fulfill these queries while also storing each translated web page. Partitioning the domain space into groups of domain addresses in advance of the search would also be problematic because the dynamic nature of the web would almost certainly result in overlapped processing in which some instances of the web-crawler would process linked web pages that have already been processed by other instances of the web-crawler application. A static partitioning would also likely result in uneven load balancing across the instances of the web-crawler application because some instances of the web-crawler would be responsible for processing a much larger number of web pages due to the randomness in the size or depth of web sites.

Using the present invention, each instance of a web-crawler application would be configured with information that allows it to operate independently of the other instances of the application. In this example, each instance would receive the number of web-crawler instances that are being deployed, e.g., “N”=10,000. Each instance would also receive the remainder value “D” that has been assigned to it, i.e. the unique, web-crawler-specific selection value. It may also be assumed that each instance of the web-crawler application receives an algorithm and/or algorithm parameters for converting a portion of a web page into a representational integer value. In addition, each instance of the web-crawler application would receive an algorithm and/or algorithm parameters for traversing the “.com” domain. Having configurable algorithms may greatly increase processing efficiency because different algorithms may be more efficient for different types of web-crawling projects.

Continuing with the application of the present invention to the web-crawler scenario, when an instance of the web-crawler application captures a web page, the web-crawler uses the conversion algorithm to generate a representational integer value for the captured web page. After calculating the remainder value from the modulo arithmetic operation, the web-crawler checks whether the computed remainder value matches the web-crawler instance's web-crawler-specific selection value. If so, then the web-crawler has determined that it has the responsibility of further processing, i.e. translating, the web page; if not, then the instance can discard the web page and continue crawling the web.

The advantages of the present invention should be apparent in view of the detailed description that is provided above. The present invention is a computationally low-cost mechanism for coordinating the activities of large numbers of distributed processors that are working on a common set of data elements. Each of many processors throughout a distributed data processing system can complete a self-selection evaluation to determine whether a processor should select itself as the unique processor within the distributed data processing system to perform further processing on a data element.

The technique of the present invention is particularly effective under the following conditions. The algorithm that is used to compute a data element's representational integer value should produce an even distribution of integers, and each processor should have the capacity to examine enough of every data element to perform the necessary modulo arithmetic. In addition, each processor should have sufficient capacity to perform the more detailed analysis for every data element for which the processor is selected. Preferably, the computational resources that are required to acquire each data element and to perform the modulo arithmetic is relatively small compared to the computational resources that are required to perform the more detailed analysis, i.e. the overhead is minimal.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method of load balancing among a plurality of processors in a distributed computing environment, the method comprising:
calculating an integer value for a data element which can be processed by a respective one of the plurality of processors;
calculating a remainder using the integer value and a number of processors in the plurality of processors; and
using the remainder to assign the data element to a respective one of the plurality of processors for processing.

2. The method of claim 1 wherein the integer value is calculated by an arbitrary one of the plurality of processors.

3. The method of claim 1 wherein the data element may be indicative of an intrusion in the distributed computing environment.

4. The method of claim 1 wherein an even distribution of integer values for data elements is calculated.

5. A method for determining processor activity, the method comprising:
retrieving at a processor a data element from a data source;
computing at the processor a representational integer value for the data element;
calculating at the processor a remainder value by dividing the representational integer value by an integer divisor number;
determining at the processor whether the remainder value is equal to a predetermined value associated with the processor; and
in response to a positive determination that the remainder value is equal to the predetermined value for the processor, processing the data element at the processor.

6. The method of claim 5 wherein the integer divisor number represents a number of processors in a distributed data processing system.

7. The method of claim 5 further comprising:
examining at the processor a consecutive next data element from the data source to determine whether the consecutive next data element is to be processed at the processor.

8. The method of claim 5 further comprising:
examining the data element at each processor of a plurality of processors in a distributed data processing system.

9. The method of claim 5 further comprising:
examining each data element from the data source at each processor of a plurality of processors in a distributed data processing system.

10. The method of claim 5 further comprising:
configuring each processor with information for an algorithm, wherein the representational integer value is computed using the algorithm.

11. The method of claim 5 wherein the processor is a hardware unit or a software unit.

12. The method of claim 5 wherein the data source is selected from the group consisting of a set of one or more data files, a set of one or more documents, or network traffic data.

13. An apparatus for load balancing among a plurality of processors in a distributed computing environment, the apparatus comprising:
a memory;
a processor;
means for calculating an integer value for a data element which can be processed by a respective one of the plurality of processors;
means for calculating a remainder using the integer value and a number of processors in the plurality of processors; and
means for using the remainder to assign the data element to a respective one of the plurality of processors for processing.

14. The apparatus of claim 13 wherein the integer value is calculated by an arbitrary one of the plurality of processors.

15. The apparatus of claim 13 wherein the data element may be indicative of an intrusion in the distributed computing environment.

16. The apparatus of claim 13 wherein an even distribution of integer values for data elements is calculated.

17. An apparatus for determining processor activity, the apparatus comprising:
a memory;
a processor;
means for retrieving at a processor a data element from a data source;
means for computing at the processor a representational integer value for the data element;
means for calculating at the processor a remainder value by dividing the representational integer value by an integer divisor number;
means for determining at the processor whether the remainder value is equal to a predetermined value associated with the processor; and
means for processing the data element at the processor in response to a positive determination that the remainder value is equal to the predetermined value for the processor.

18. The apparatus of claim 17 wherein the integer divisor number represents a number of processors in a distributed data processing system.

19. The apparatus of claim 17 further comprising:
means for examining at the processor a consecutive next data element from the data source to determine whether the consecutive next data element is to be processed at the processor.

20. The apparatus of claim 17 further comprising:
means for examining the data element at each processor of a plurality of processors in a distributed data processing system.

21. The apparatus of claim 17 further comprising:
means for examining each data element from the data source at each processor of a plurality of processors in a distributed data processing system.

22. The apparatus of claim 17 further comprising:
means for configuring each processor with information for an algorithm, wherein the representational integer value is computed using the algorithm.

23. The apparatus of claim 17 wherein the processor is a hardware unit or a software unit.

24. The apparatus of claim 17 wherein the data source is selected from the group consisting of a set of one or more data files, a set of one or more documents, or network traffic data.

25. A computer program product in a computer readable medium for load balancing among a plurality of processors in a distributed computing environment, the computer program product comprising:
means for calculating an integer value for a data element which can be processed by a respective one of the plurality of processors;
means for calculating a remainder using the integer value and a number of processors in the plurality of processors; and
means for using the remainder to assign the data element to a respective one of the plurality of processors for processing.

26. The computer program product of claim 25 wherein the integer value is calculated by an arbitrary one of the plurality of processors.

27. The computer program product of claim 25 wherein the data element may be indicative of an intrusion in the distributed computing environment.

28. The computer program product of claim 25 wherein an even distribution of integer values for data elements is calculated.

29. A computer program product in a computer readable medium for use in a data processing system for determining processor activity, the computer program product comprising:
means for retrieving at a processor a data element from a data source;
means for computing at the processor a representational integer value for the data element;
means for calculating at the processor a remainder value by dividing the representational integer value by an integer divisor number;
means for determining at the processor whether the remainder value is equal to a predetermined value associated with the processor; and
means for processing the data element at the processor in response to a positive determination that the remainder value is equal to the predetermined value for the processor.

30. The computer program product of claim 29 wherein the integer divisor number represents a number of processors in a distributed data processing system.

31. The computer program product of claim 29 further comprising:
means for examining at the processor a consecutive next data element from the data source to determine whether the consecutive next data element is to be processed at the processor.

32. The computer program product of claim 29 further comprising:
means for examining the data element at each processor of a plurality of processors in a distributed data processing system.

33. The computer program product of claim 29 further comprising:
means for examining each data element from the data source at each processor of a plurality of processors in a distributed data processing system.

34. The computer program product of claim 29 further comprising:
means for configuring each processor with information for an algorithm, wherein the representational integer value is computed using the algorithm.

35. The computer program product of claim 29 wherein the processor is a hardware unit or a software unit.

36. The computer program product of claim 29 wherein the data source is selected from the group consisting of a set of one or more data files, a set of one or more documents, or network traffic data.
